(19) United States
(12) Patent Application Publication
(10) Pub. No.: US 2004/0240739 A1
(43) Pub. Date: Dec. 2, 2004

(54) Pen gesture-based user interface

(76) Inventors: Lu Chang, Cupertino, CA (US); Giovanni Seni, Mountain View, CA (US); Peng Zhan, Cupertino, CA (US)

Correspondence Address: LARSON + ASSOCIATES PC, 221 EAST CHURCH ST., FREDERICK, MD, 21701, US

(21) Appl. No.: 10/448,768

(22) Filed: May 30, 2003

(51) Int. Cl. G06K 9/18

(52) U.S. Cl. 382/186

(57) ABSTRACT

A user interface for an electronic device has a pen based input device (256) that captures a collection of coordinates that correspond to handwritten information. According to certain embodiments, a processor (260) carries out a command recognition process in which a command gesture (124, 130, 134, 138, 142, 144, 148) is recognized (210) in the collection of coordinates. The command gesture identifies a set of coordinates form at least a portion of the collection of coordinates that represent a command (120). The identified coordinates are then extracted (220) and translated to a command (230) for execution (244).

### FIELD OF THE INVENTION

This invention relates generally to the field of user interfaces for electronic devices. More particularly, certain embodiments consistent with the present invention relate to a pen gesture-based user interface.

### BACKGROUND OF THE INVENTION

Portable electronic devices such as cellular telephones, messaging devices, and PDAs (personal digital assistants) conventionally use one of several types of user interfaces including keypads, touch screens and voice recognition. However, recently a new kind of input device has emerged. This device is a virtual pen input device that allows users to write on paper with a traditional inking pen while capturing the ink trace in a digital format. Such ink capture devices are currently commercially available from a number of manufactures. These pen-input devices connect with a PDA or PC (personal computer) through inferred (IR), USB (Universal Serial Bus), or Bluetooth, but could be adapted to any suitable input interface.

Most of these pen input devices provides only the ink data stream and relies on computing devices, such as, PDA, telephone, or laptop computer, for storage and manipulation of the “ink data”—that is, the collection of X-Y coordinates defining handwritten traces on paper with pen. Hence, these input devices do not currently operate stand-alone, but are viewed as an “accessory” to an electronic device for which it provides input.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is an illustration of handwritten text and a pen gesture consistent with certain embodiments of the present invention;

FIG. 2-3 illustrate exemplary circular closed form pen gestures consistent with certain embodiments of the present invention;

FIG. 4-5 illustrate exemplary rectangular closed form pen gestures consistent with certain embodiments of the present invention;

FIG. 6-9 illustrate exemplary open form pen gestures consistent with certain embodiments of the present invention;

FIG. 10 is a flow chart of a process for manipulating pen gestures representing command gestures in a manner consistent with certain embodiments of the present invention;

FIG. 11 is a block diagram of a pen input processing system consistent with certain embodiments of the present invention; and

FIG. 12 is a block diagram of an exemplary pen input messaging system consistent with certain embodiments of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding elements in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

In accordance with certain embodiments consistent with the present invention, a pen input device can be used in conjunction with a portable or mobile electronic device such as for example a PDA, messaging device or wireless telephone as either an accessory input device or as the primary input device. When such a pen input device is utilized as the primary input mechanism for such a portable electronic device, it may have a rather small writing area. In order to achieve an effective interface, commands that normally require multiple key presses on a small keypad may be replaced by a simple handwritten word/phrase that is recognized as such by software.

Several types of pen input devices are currently commercially available and others in development. Some such devices utilize a touch sensitive medium either alone or covered by paper. Others use specialized paper in conjunction with a camera embedded within a pen or stylus-like device that photographs the paper and ink. The paper uses a special coding of dots to permit the system to ascertain the exact location of a pen trace on the paper. Other systems, such as the InkLink™ commercially available from Seiko Instruments USA, Inc., utilizes ultrasound transducers to generate sound waves that bounce off the pen or stylus to permit triangulation of the location of the pen as it makes a trace on ordinary paper. Any of these types of systems, as well as any other device that can be utilized to capture an ink trace or trace of a stylus can be used as a suitable pen input device consistent with certain embodiments of the present invention.

Using a pen input device together with a mobile or portable electronic device, one can enter “ink data” into the device by simply writing on paper in a normal manner. As the user writes, ink data in the form of X-Y coordinates of a pen or virtual pen or stylus trace are captured and stored in digital format as an ink document or equivalent graphics or handwriting file with spatial relationships of ink points preserved. In accordance with certain embodiments consistent with the present invention, the user accesses system functions on the device, such as, looking up contact information by writing a command on the paper. However, there should be some mechanism for the electronic device to differentiate between input data that is captured as an ink document and an actual command. In order to differentiate ink data meant to be recognized as a command, a special “pen gesture” or “command gesture” is used to segregate the command from other information. In accordance with certain embodiments consistent with the present invention, the command can be distinguished by drawing a shape (i.e., the command gesture) that encircles, encloses or otherwise sets apart the written command by defining an area of the paper or other writing surface that contains a command. The system will then extract those handwriting coordinates that are set apart by the command gesture for interpretation as a command, convert the ink coordinates to text, interpret text into system command format, and apply the command.

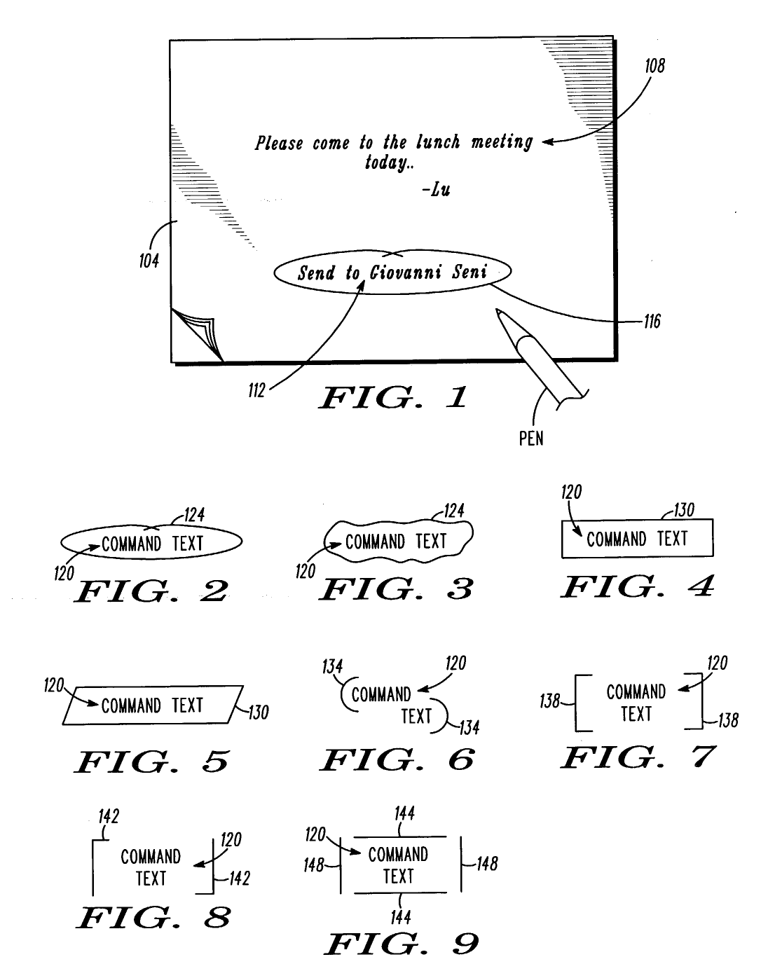

This is illustrated, by way of example, in FIG. 1 that depicts a paper or other writing area (e.g., electronic touch sensitive display) 104, that the user can use to capture handwritten text, messages, sketches and other information. In this example, the user can utilize the interface to generate a message and send it, as for example in an electronic messaging scenario, email or file transfer. In this exemplary embodiment, the message is created as a simple handwritten message 108 reading “Please come to the lunch meeting today—Lu.” This message 108 is captured in digital form as an ink document, for example (i.e., a digital file representing the X-Y coordinates of the location of the ink on the paper). This message can then be stored or communicated electronically by any suitable file transfer mechanism.

The user can then write out a command 112 in a suitably defined command syntax using handwriting to convey the command 112. In this example, the command is to send the ink file to Giovanni Seni. In order to distinguish the command from other information on the page, a command gesture 116 is made that segregates the command from the other information on the page. In this example, the command gesture is simply a handwritten closed form that encircles the handwritten command 112. Since this is an easily recognized pen gesture, it provides the electronic device with enough information to determine that a command is (or may be) enclosed within the boundaries of the pen gesture. The system can then apply handwriting recognition techniques to the command, extract the meaning of the command and execute the command.

Thus, a command entry method consistent with certain embodiment of the present invention involves writing a handwritten command using a command syntax; and segregating the handwritten command from non-commands by using a handwritten command gesture associated with the command. The handwritten command and gesture can be entered using a pen input device such as an ink capture device or a stylus and touch sensitive medium. The gesture may be any suitable open or closed form geometric shape.

This method of combining the command gesture and written commands results in a simple process of issuing commands. The user merely draws the gesture to signal the presence of a command and to make sure that the written command is within the gesture boundary. A benefit of a written command, in certain embodiments consistent with the present invention, is that due to the use of natural language in command, a much richer and more flexible command structure is possible than other predefined commands, for example, menu driven commands, but this should not be considered a limitation on the current invention.

In order to simplify the activation of commands, simple shapes are preferred as command gestures, such as, circles and rectangles. These regular shapes are chosen because they are easy for users to use and are also easy for the system to detect. In this context, the term “circle” or “encircle” is intended to mean any encircling gesture such as that of FIG. 1, FIG. 2 and FIG. 3 and should not be limited to the mathematical definition of a circle, owing to the difficulty of drawing a perfect circle. All that is meant, is that the handwriting corresponding to the command text 120 is encircled by the “circle” command gesture 124, which may more properly approximate an oval, ellipse or any other suitable regular or irregular closed geometric form.

In other embodiments consistent with the present invention, the pen gesture can be defined as a rectangle as illustrated in FIG. 4, or other line based closed form such a polygon, parallelogram, a trapezoid, triangle or other regular or irregular closed geometric form 130 enclosing the command text 120. For example, a parallelogram is shown in FIG. 5 which can be used to enclose the command text 120.

While closed form geometric shapes may be best to represent the pen gesture that represents a command due to the simplicity of the gesture, in other embodiments consistent with the present invention, open form geometric shapes might also be used to segregate commands from other handwritten information. Examples of such open form geometric shaped gestures are shown in FIGS. 6-9. In each of these gestures, an open form geometric shape is used to define boundaries of a handwritten command. FIG. 6 uses semicircular brackets 134 to define command boundaries around command 120. FIG. 7 uses rectangular brackets 138 to define command boundaries around command 120. FIG. 8 uses a pair of L-shaped framing corners 142 to define command boundaries around command 120. FIG. 9 uses horizontal lines 144 and vertical lines 148 to define command boundaries around command 120. In other embodiments, other open form geometric shapes including simply underlining and/or overlining or use of vertical lines can be used to define the boundaries of the command text 120 as will become apparent to those skilled in the art upon consideration of the present teaching.

In order to simplify command interpretation and increase recognition of handwriting traces, it is desirable to limit the syntax for commands. For example, it is preferable to have the following commands in a mobile communication messaging device:

Send/email to NAME;
Save to FILE;
Keyword TAG;
Add NAME to addressbook;
Add NAME NUM to phonebook.

where NAME could be names in the “phonebook” application on the device and NUM stands for phone numbers. FILE is a file name. TAG could be a set of words. Clearly, the list of commands is not limited by those mentioned above, since any suitable limited set of commands will serve the purpose of simplifying recognition and command entry.

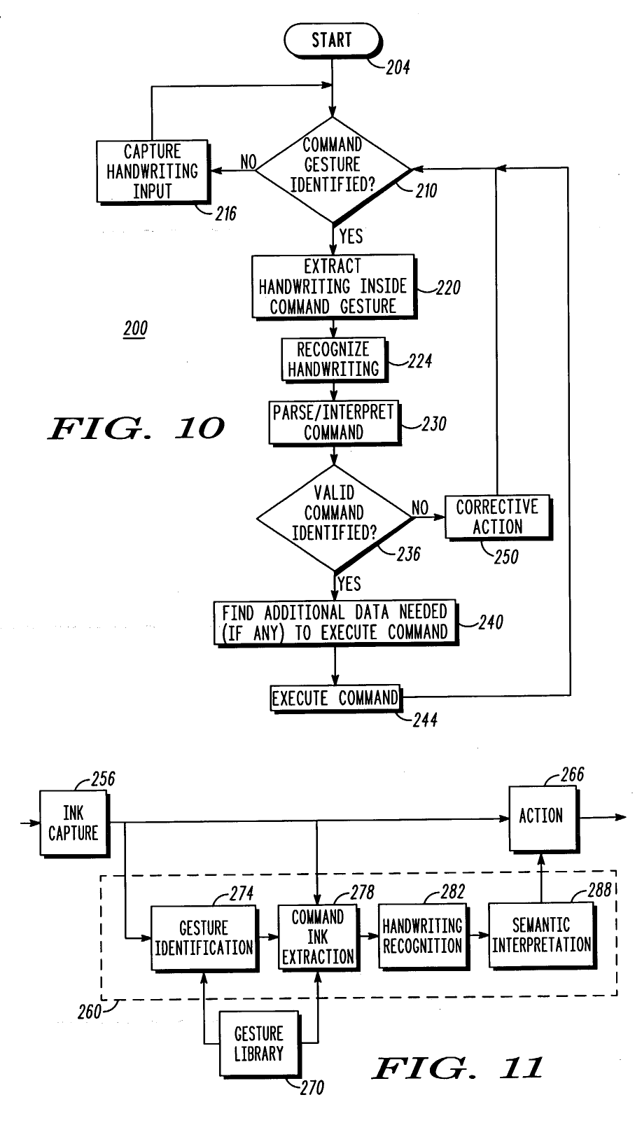

With reference to FIG. 10, an exemplary process 200 consistent with certain embodiments of the present invention is illustrated starting at 204. As information is placed on the input device using handwriting, the handwriting is continually examined at 210 to identify any defined pen gestures that indicate that a command has been segregated (i.e., a command gesture). If no such command gesture is identified, the handwriting is captured as input to an ink document (or any other suitable graphics or handwriting file) at 216. The process then returns to 210.

Once a command gesture is identified (or tentatively identified) at 210, the process extracts the handwriting bounded by the command gesture at 220. The handwriting is then passed to a handwriting recognition process 224 in order to convert the handwriting to text. At 230, the text is parsed and interpreted as a command. If the command is valid (i.e., has valid syntax, etc.) at 236, the process finds any additional information needed (if any) to execute the command at 240. For example, in the exemplary embodiment of FIG. 1, the process may query a database to find an email address or other contact information associated with the message recipient. In other embodiments, missing information may be queried of the user (e.g., the process can query the user for a missing file name in order to store the ink document as a file). Once all of the information needed has been obtained, the command is executed at 244 and control returns to 210 where handwriting capture and the search to identify command gestures proceeds at 210 and 216.

In the event a valid command is not identified at 236, corrective action can be initiated at 250. Such corrective action can take many forms. One example of corrective action may simply be to capture the pen gesture and anything segregated by the gesture as a part of the ink document file. This approach assumes that the gesture was actually part of a sketch or the like and not intended to segregate a command. In other embodiments, corrective actions can involve requesting that the command be rewritten or entered using another input mechanism. Other variations of error trapping and corrective action will occur to those skilled in the art upon consideration of the current invention.

Thus, in accordance with certain embodiments consistent with the present invention, a user interface method for an electronic device involves capturing a collection of coordinates that correspond to handwritten information on an input device; recognizing a command gesture in the collection of coordinates, the command gesture identifying a set of coordinates forming at least a portion of the collection of coordinates as representing a command; and translating the identified coordinates to the command. The command can then be executed on the electronic device. The translating process can involve extracting the set of coordinates from the collection of coordinates; recognizing handwriting in the set of coordinates; and interpreting the handwriting as a command. The command is identified by determining that the set of coordinates is enclosed by a particular open form or closed form geometric shape.

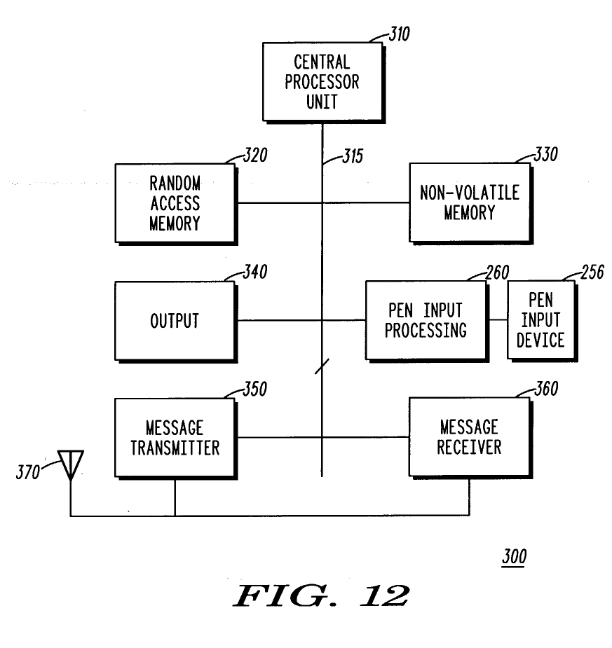

FIG. 11 depicts an exemplary pen input processing system consistent with certain embodiments of the present invention operating in accordance with the process 200 described above. Ink/pen input is captured at a pen capture device 256 and the captured handwriting is sent to a pen input processing circuit or process 260. The handwritten input and commands are processed by the pen input circuit 260 and, if a command is detected, the command is translated and sent out for action at 266. A library 270 of command gestures contains information that defines the characteristics of a pen gesture that represents a command. This library can be in any suitable form that is useful to provide a reference to the pen input processing circuit or process 260, including, but not limited to, look-up tables or other conveyances of characteristics that define a command gesture.

A gesture identification block 274 compares input from the ink capture device 256 with characteristics in the gesture library 270 to determine if a command gesture has been input. If so, a command ink extraction block 278 uses information from the gesture library to isolate and extract the handwritten command from the remaining handwritten information on the page and from the command gesture itself. The handwritten command is then passed to a handwriting recognition block 282, which converts the handwriting to text and passes the text to a semantic interpretation block 288 which parses the text and interprets the command. The interpreted command is then output for action at 266 by the electronic device. Other equivalent devices can be devised in view of the foregoing description without departing from the present invention.

The processes previously described can be carried out in any suitable electronic device such as an electronic messaging device having a programmed general purpose computer system forming a part thereof, such as the exemplary device 300 depicted in FIG. 12. Messaging device 300 has a central processor unit (CPU) 310 with an associated bus 315 used to connect the central processor unit 310 to Random Access Memory 320 and/or Non-Volatile Memory 330 (which may include ROM, EEPROM, disc storage, etc.) in a known manner. This non-volatile memory can be used to store the gesture library 270 described above. An output mechanism at 340 may be provided in order to display and/or print output for the messaging device user. A pen input device 256 is provided for the input of information by the user in the manner previously described. Pen input processing circuitry (e.g., a programmable processor or dedicated hardware) provides the gesture interpretation and handwriting recognition functions, etc., as previously described. In other embodiments, the pen input processing can be carried out in central processor 310 and the pen input processing circuit 260 eliminated. Messaging system 300 also includes a messaging transmitter 350 and a messaging receiver 360 coupled to an antenna 370 to transmit and receive messages. The nonvolatile memory 330 can be used to store not only operating system, control programs and the gesture library, but also databases of useful information and other computer programs and data such as address managers, communication software, calendars, word processing and other suitable programs.

Thus, in accordance with certain embodiments consistent with the present invention, a user interface for an electronic device has an input device that captures a collection of coordinates that correspond to handwritten information. A circuit recognizes a command gesture in the collection of coordinates, the command gesture identifying a set of coordinates forming at least a portion of the collection of coordinates as representing a command. Handwriting is recognized in the set of coordinates and the handwriting is converted to text. A semantic interpreter translates the text into the command which can then be executed on the electronic device. The input device can be a pen input device or other suitable device that captures handwritten input. Commands are recognized by determining that the set of coordinates is enclosed by a closed form or open form geometric shape.

In another embodiment consistent with the present invention, a user interface for an electronic device has an input device that captures a collection of coordinates that correspond to handwritten information. A processor, such as a dedicated or shared programmed or fixed processor carries out a command recognition process that involves: recognizing a command gesture in the collection of coordinates, the command gesture identifying a set of coordinates forming at least a portion of the collection of coordinates as representing a command; and translating the identified coordinates to the command. The input device can be a pen input device or other suitable device that captures handwritten input. Commands are recognized by determining that the set of coordinates is enclosed by a closed form or open form geometric shape.

By use of certain embodiments consistent with the present invention, a new way for mobile users to interact with their mobile device is provided through the use of a virtual pen. In other embodiments, the same or similar techniques can be used to differentiate commands from other input using other input devices such as touch sensitive screens and the like. Through the use of pen gestures, users can easily control system behaviors and access system resources and functions by writing the command on a normal piece of paper. This eliminates or minimizes the need for users to alternate their attention between using the physical pen and paper interface, and using buttons on the device.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using any suitable computer readable storage medium such as for example disc storage, Read Only Memory (ROM) devices, Random Access Memory (RAM) devices, semiconductor storage elements, optical storage elements, magnetic storage elements, magneto-optical storage elements, flash memory, core memory and/or other equivalent storage technologies without departing from the present invention. Such alternative storage devices should be considered equivalents.

The present invention, as described in embodiments herein, is implemented using a programmed processor executing programming instructions that are broadly described above in flow chart form that can be stored on any suitable computer readable storage medium (e.g., disc storage, optical storage, semiconductor storage, etc.) or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent. While the current embodiment goes through the step of handwriting recognition and interpretation, it is possible that certain embodiments could be devised that would directly interpret instructions bounded by the command gesture without need to translate to text first. Other embodiments will become apparent to those skilled in the art upon consideration of these teachings.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A user interface method for an electronic device, comprising:
capturing a collection of coordinates that correspond to handwritten information on an input device;
recognizing a command gesture in the collection of coordinates, the command gesture identifying a set of coordinates forming at least a portion of the collection of coordinates as representing a command; and
translating the identified coordinates to the command.

2. The user interface method according to claim 1, further comprising executing the command on the electronic device.

3. The user interface method according to claim 1, wherein the translating comprises:
extracting the set of coordinates from the collection of coordinates;
recognizing handwriting in the set of coordinates; and
interpreting the handwriting as a command.

4. The user interface method according to claim 1, further comprising obtaining additional information from storage to execute the command.

5. The user interface method according to claim 1, wherein the input device comprises a pen input device.

6. The user interface method according to claim 1, wherein the identifying is carried out by determining that the set of coordinates is enclosed by a closed form geometric shape.

7. The user interface method according to claim 6, wherein the closed form geometric shape comprises at least one of an ellipse, a circle, an oval, a polygon, a rectangle, a triangle and an irregular closed form.

8. The user interface method according to claim 1, wherein the identifying is carried out by determining that the set of coordinates has boundaries defined by one or more open form geometric shapes.

9. The user interface method according to claim 8, wherein the open form geometric shapes comprise at least one of brackets, semicircles, free form curves, lines and framing corners.

10. A computer readable storage medium containing instructions that, when executed on a programmed processor carries out a user interface process in accordance with claim 1.

11. A user interface for an electronic device, comprising:
an input device that captures a collection of coordinates that correspond to handwritten information;
means for recognizing a command gesture in the collection of coordinates, the command gesture identifying a set of coordinates forming at least a portion of the collection of coordinates as representing a command;
means for recognizing handwriting in the set of coordinates and converting the handwriting to text; and
a semantic interpreter that translates the text into the command.

12. The user interface according to claim 11, further comprising means for executing the command on the electronic device.

13. The user interface according to claim 1 1, wherein the input device comprises a pen input device.

14. The user interface according to claim 11, wherein the command is recognized by determining that the set of coordinates is enclosed by a closed form geometric shape.

15. The user interface according to claim 14, wherein the closed form geometric shape comprises at least one of an ellipse, a circle, an oval, a polygon, a rectangle, a triangle and an irregular closed form.

16. The user interface according to claim 11, wherein the command is recognized by determining that the set of coordinates has boundaries defined by one or more open form geometric shapes.

17. The user interface according to claim 16, wherein the open form geometric shapes comprise at least one of brackets, semicircles, free form curves, lines and framing corners.

18. A user interface for an electronic device, comprising:
an input device that captures a collection of coordinates that correspond to handwritten information;
a processor that carries out a command recognition process comprising:
recognizing a command gesture in the collection of coordinates, the command gesture identifying a set of coordinates forming at least a portion of the collection of coordinates as representing a command; and
translating the identified coordinates to the command.

19. The user interface according to claim 18, wherein the processor carries out the command recognition process by execution of a computer program.

20. The user interface according to claim 18, further comprising executing the command on the electronic device.

21. The user interface according to claim 18, wherein the translating comprises:
extracting the set of coordinates from the collection of coordinates;
recognizing handwriting in the set of coordinates; and
interpreting the handwriting as a command.

22. The user interface according to claim 18, further comprising a storage device that stores retrievable information to execute the command.

23. The user interface according to claim 18, wherein the input device comprises a pen input device.

24. The user interface according to claim 18, wherein the identifying is carried out by determining that the set of coordinates is enclosed by a closed form geometric shape.

25. The user interface according to claim 24, wherein the closed form geometric shape comprises at least one of an ellipse, a circle, an oval, a polygon, a rectangle, a triangle and an irregular closed form.

26. The user interface according to claim 18, wherein the identifying is carried out by determining that the set of coordinates is has boundaries defined by one or more open form geometric shapes.

27. The user interface according to claim 26, wherein the open form geometric shapes comprise at least one of brackets, semicircles, free form curves, lines and framing corners.

28. A method of using an interface to an electronic device, comprising:
writing a handwritten command using a command syntax; and
segregating the handwritten command from non-commands by using a handwritten command gesture associated with the command.

29. The method according to claim 28, wherein the handwritten command and gesture are entered using a pen input device.

30. The method according to claim 28, wherein the gesture comprises a closed form geometric shape.

31. The method according to claim 30, wherein the closed form geometric shape comprises at least one of an ellipse, a circle, an oval, a polygon, a rectangle, a triangle and an irregular closed form.

32. The method according to claim 28, wherein the gesture comprises one or more open form geometric shapes.

33. The method according to claim 32, wherein the open form geometric shapes comprise at least one of brackets, semicircles, free form curves, lines and framing corners.
